(19) United States
(12) Patent Application Publication
(10) Pub. No.: US 2008/0095525 A1
(43) Pub. Date: Apr. 24, 2008

(54) ADJUSTABLE AUXILIARY CAMERA POWER PACK

(75) Inventors: KEVIN MAGGERT, LAWRENCEVILLE, GA (US); CHARLES FRIEDLI, LAWRENCEVILLE, GA (US); DUE Q. HUYNH, LAWRENCEVILLE, GA (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/550,883

(22) Filed: Oct. 19, 2006

(51) Int. Cl. G03B 7/26

(52) U.S. Cl. 396/301

(57) ABSTRACT

Included is an adjustable, auxiliary battery pack suitable for digital cameras. The pack includes a rotary wheel having finger grips that protrude through slots in a rotary wheel guide. The finger grips, in conjunction with the large diameter of the rotary wheel, allow a user to couple a threaded screw disposed in the rotary wheel to a tripod mount in a camera. The rotary wheel guide includes an aperture that allows the rotary wheel to move both side to side and forward and back, thereby accommodating a wide array of digital camera form factors. A protrusion on the rotary wheel ensures that the moveable rotary wheel stays within the confines of the rotary wheel guide. The battery pack includes a female tripod mount on the bottom of the pack that allows the camera/battery pack assembly to be coupled to a tripod.

### BACKGROUND

1. Technical Field

This invention relates generally to auxiliary power devices for electronic equipment, and more specifically to an adjustable auxiliary power pack with a simplified release mechanism for photographic cameras.

2. Background Art

Traditionally, photographic cameras were mechanical devices that required no electrical power. A user loaded film manually, advanced the film manually, and focused the lens manually. To take a picture, the user depressed a button causing a shutter to open mechanically. With the exception of an external flash, no electrical power was required. While a flash did require a modicum of power, it was easily supplied by a small, non-rechargeable battery.

With the advent of digital cameras, however, electrical power is now mandatory. Digital cameras include color screens, microprocessors, auto-focus motors, and digital memories, all of which consume a good deal of power. While the cameras of yesteryear had no battery, today's digital cameras depend upon batteries for operability. A typical digital camera today comes with an embedded, rechargeable lithium-ion battery. Such a battery is capable of supplying power for approximately 50 pictures before a recharge is necessary.

For heavy users of digital cameras, including enthusiasts, vacationers and journalists, this batter capacity may prove insufficient. Such users may need to shoot hundreds of pictures, and need to do so without stopping to recharge the battery. For this reason, auxiliary batteries have been developed. For example, Pat. Application Ser. No. WO0050955, filed Feb. 22, 2000, entitled “Digital Camera Adaptor Assembly”, inventors Kalil et al., teaches a detachable adaptor assembly that includes at least one secondary battery.

The problem with this prior art solution is that it only fits one camera. For example, a user with both a Minolta and Canon cameras would need to buy two of these batteries, each custom made to fit the particular cameras, respectively. This is not only expensive, but also cumbersome as well. Two batteries are bulky to carry around, not to mention the two additional chargers.

U.S. Pat. No. 4,752,792, entitled “Camera Support and Accessory Storage Apparatus Storagrip” provides an auxiliary compartment with an adjustable attachment means. Such a compartment is shown in FIG. 1. As most quality cameras include a tripod mount having a threaded cylindrical bore, the accessory 25 couples to the camera 11 by way of a laterally adjusting screw 17 that couples to the threaded cylindrical bore of the tripod mount 15. This lateral adjustment 18 is advantageous because camera manufacturers often put their tripod mounts in different positions on different models.

The problem with the attachment means of FIG. 1 is that the laterally adjusting screw is disposed within an open pocket 17. Consequently, a user must reach inside the compartment 24 (removing any contents of course), avoid bumping into the walls, and twist the laterally adjusting screw 17. This will be quite difficult for anyone but those with the most slender fingers.

Additionally, such a screw mechanism 17 is impossible to use with the rechargeable battery pack. This is because a rechargeable battery would need to be placed into that area currently represented by the compartment 24. Manufacturers are generally not amenable to making rechargeable batteries removable from their housings due to safety concerns. Thus, in the rechargeable battery application, the laterally moving screw 17 of FIG. 1 would be inaccessible to the user.

There is thus a need for an improved auxiliary battery pack for a digital camera wherein the battery pack includes an adjustable attachment mechanism suitable for multiple camera form factors.

### BRIEF DESCRIPTION OF THE DRAWINGS

FIG. 1 illustrates a prior art battery storage compartment.

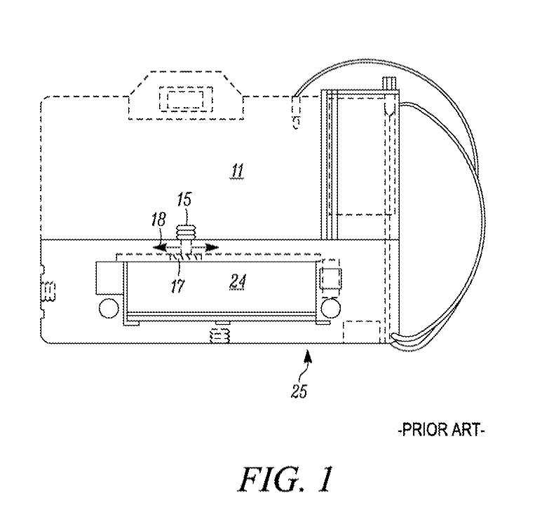

FIG. 2 is an exploded view of a battery pack in accordance with the invention.

FIG. 3 is an assembled view of a battery pack in accordance with the invention.

FIG. 4 is an exploded view, from the bottom, of a battery pack in accordance with the invention.

FIG. 5 is a perspective view of the left and back sides of the battery pack of FIG. 3 as it is assembled, and electrically connected, to an exemplary electronic device.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

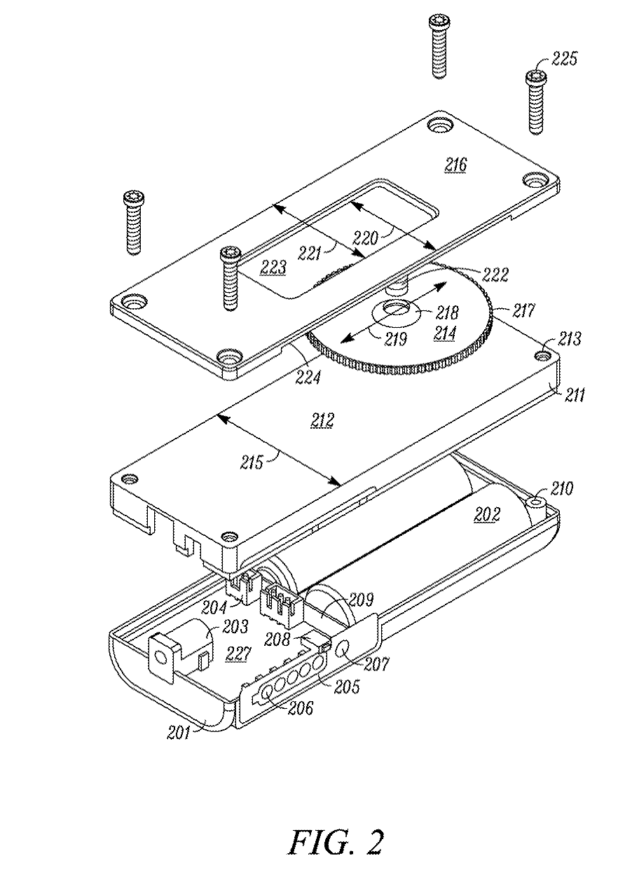

Referring now to FIG. 2, illustrated therein is an exploded view of an improved auxiliary battery pack 200 in accordance with the invention. It one preferred embodiment, the battery pack 200 includes a bottom housing 201 for holding at least one rechargeable cell 202. The bottom housing 201 further includes space for holding a printed circuit board 227. The printed circuit board 227 includes electronic circuitry associated with the battery pack 200. Such circuitry may include charging circuitry for ramping, tapering and stepping voltage and current, protection circuitry to ensure the cells 202 are not over charged, fuel gauging circuitry for determining charge status of the cells 202, and headers 203,204 for coupling both to the outside world and within the battery pack 200.

In some embodiments, a fuel gauge display 205 is provided. The fuel gauge display may include an optical output. For example, a bank of light emitting diodes (LEDs) 206 may be provided. The LEDs 206 may be actuated by way of a button 207 coupled to a switch 208 disposed on the circuit board 227. The bottom housing 201 may additionally contain vertical walls 209 for holding the cells 202 in place. It may also include screw bosses 210 to hold the battery pack 200 together.

An upper housing 212 is provided. The upper housing 212 includes at least one substantially flat surface for supporting the rotary wheel 214. The upper housing 212 includes screw holes 213 that mate with the screw bosses 210 in the lower housing 201.

The adjustable coupling mechanism comprises two components: a rotary wheel 214 and a rotary wheel guide 216. The rotary wheel 214 is generally a flat disc, preferably having finger grips 217 disposed about the circumference. A protrusion 218 is provided to ensure that the rotary wheel 214 stays within the confines of the rotary wheel guide 216. A threaded screw 222 for mating to a camera tripod mount is disposed in the center of the rotary wheel 214.

The rotary wheel guide 216 includes an aperture 223 into which the protrusion 218 and threaded screw 222 are inserted. The rectangular shape of the aperture 223 allows the rotary wheel to move both side to side and forward to back, so as to accommodate a wide array of camera tripod mount placements. The rotary wheel guide 216 includes slots that allow the edges of the rotary wheel 214 to pass through.

The diameter 219 of the rotary wheel 214 is greater than the width 215 of the upper housing 212. The diameter of the rotary wheel 214 is preferably greater than twice the distance from the edge of the aperture to the opposite edge of the rotary wheel guide 220,221. This ensures that the outer edges of the rotary wheel 214 are always exposed through the slots 224 no matter where the protrusion 218 is within the aperture 223. The result is that a user may twist the rotary wheel 214 from both sides of the pack simultaneously to screw the threaded screw 222 into the tripod mount on a camera.

The rotary wheel guide 216 is preferably coupled to the pack by way of screws 225. Other attachment means could equally be used, including ultrasonic welds, glue, snaps and the like. The housings and guide 201,212,216 are preferably manufactured from injection molded plastic. A suitable material would be ABS plastic or a polycarbonate plastic.

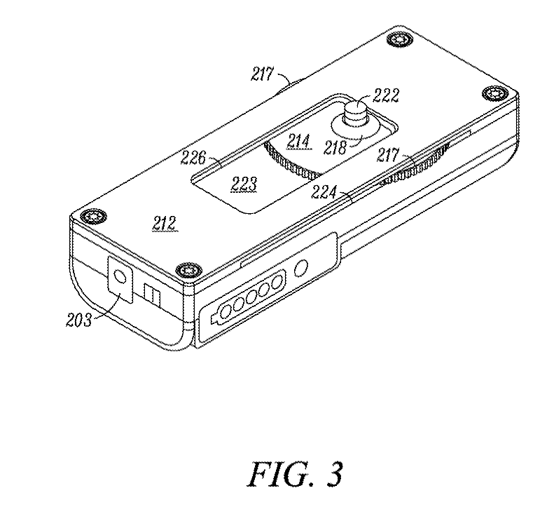

Referring now to FIG. 3, illustrated therein is an assembled pack in accordance with the invention. As can be seen, the finger grips 217 protrude through the slots 224 of the rotary wheel guide 212. This allows the user to easily cinch the threaded screw 222 into the tripod mount of a camera by rotating the rotary wheel. Note that the protrusion 218 contacts the sides 226 of the aperture 223 to keep the “floating” rotary wheel 214 within the confines of the rotary wheel guide 223. A power supply connector or header 203 is provided to couple to a power supply for recharging the cells within the pack.

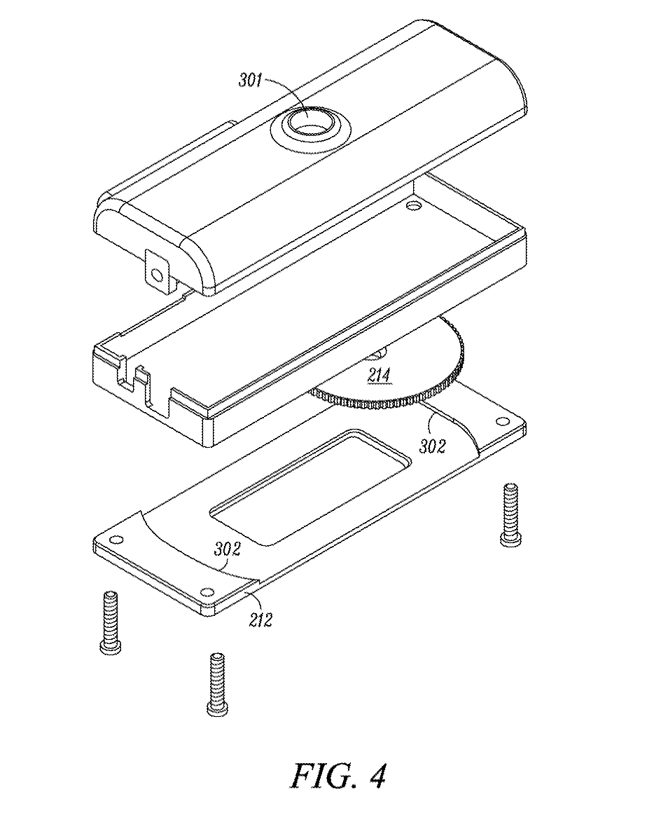

Referring now to FIG. 4, illustrated therein is an exploded view of the battery pack 200 looking from the bottom. As the camera's tripod mount is occupied when the battery pack 200 is coupled to the camera, a female tripod mount 301 is provided for coupling the camera-battery pack assembly to a tripod. Additionally, curved rotary wheel guides 302 are provided on the underside of the rotary wheel guide 212 to help ensure that the rotary wheel stays within the confines of the rotary wheel guide 212.

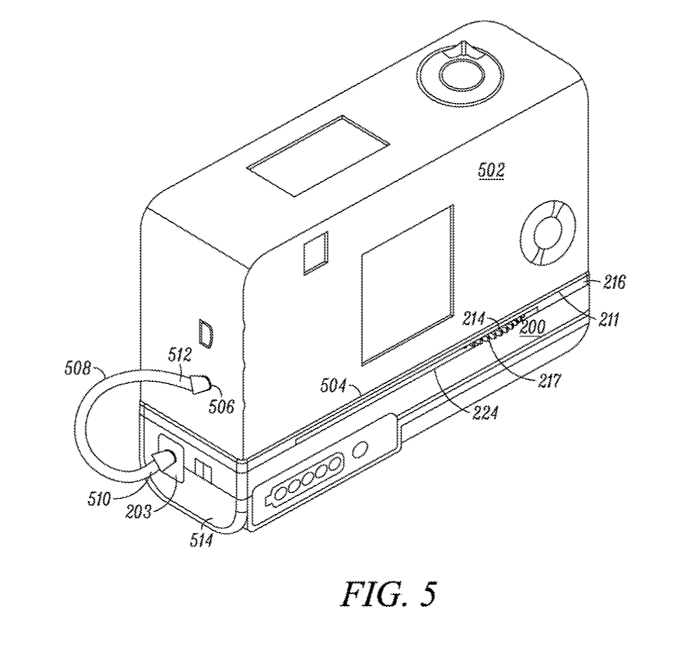

Referring to FIG. 5, illustrated therein is a perspective view of the battery pack 200 when it is attached to an electronic device 502 that requires electrical power, such as a digital camera. As stated above, the bottom housing 201 of the battery pack 200 holds at least one rechargeable cell 202 and the printed circuit board 227 that includes electronic circuitry associated with the battery pack. Such circuitry may include charging circuitry for ramping, tapering and stepping voltage and current, protection circuitry to ensure the cells 202 are not over charged, fuel gauging circuitry for determining charge status of the cells 202, and headers 203,204 for coupling both to the outside world and within the battery pack 200.

The adjustable coupling mechanism includes the rotary wheel 214 supported by the rotary wheel guide 216. The threaded screw 222 is disposed on, and extended upward from, the rotary wheel 214, through the aperture 223 of the rotary wheel guide 216, for mating to a camera tripod mount of the electronic device 502. Thus, the rotary wheel guide 216 positions an upper surface 211 of the rotary wheel guide adjacent to a bottom surface 504 of the electronic device 502. For example, the electrical device may be a digital camera including a camera tripod mount having a threaded cylindrical bore. The threaded screw 222 may couple to the threaded cylindrical bore to support the upper surface 211 of the battery pack 200 to the bottom surface 504 of the digital camera.

In addition to the mechanical coupling between the battery pack 200 and the electronic device 502, an electrical coupling is provided between these components. The electronic device 502, such as a digital camera, may have a power connector 506 so that power sources external to the electric device may provide electrical power to the device. Optionally, the power connector 506 may also be used to supply power to devices external to the electronic device 502.

The battery pack 200 also includes a header 203 for coupling various electronic components of the battery pack, such as the rechargeable cell(s) 202 and/or circuit board 227, to devices external to the battery pack. For example, as shown in FIG. 5, an electrical conductor or cable 508 couples the power connector 506 of the electronic device 502 to the header 203 of the battery pack 200. In particular, the cable 508 has a first end 510 capable of coupling to the header 203 of the battery pack 200 and a second end 512 capable of coupling to the power connector 506 of the electronic device 502. The cable 508 shown in FIG. 5 is a flexible cable which is one embodiment of the electrical conductor, but the cable may have a varying properties, so long as it serves the purpose of conducting electricity between the battery pack 220 and the electronic device 502. For example, the cable 508 may be rigid or semi-rigid instead of flexible in another embodiment. Also, the first end of the cable 508 may be affixed or removably connected (by a user without tools) to the header 203, but the second end 512 of the cable is preferably removably connected to the power connector 506.

It is desirable to position the header 203 of the battery pack 200 away or remote from the portion of the battery pack 200 that is adjacent to the electronic device 502, such as, the upper surface 211 of the rotary wheel guide 216, when the battery pack and the electronic device are mechanically coupled to each other. For example, as shown in FIG. 5, the upper surface 211 of the rotary wheel guide 216, including the camera tripod mount, may be substantially concealed when the rotary wheel 214 is coupled to the camera tripod mount, but the header 203 remains exposed. For this embodiment, the header 203 is positioned at an external surface 514 of the battery pack 200 other than the upper surface 211. By configuring the battery pack 200 in this manner, the electrical conductor 508 may still have access to the header 203, even when the upper surface of the battery pack 200 (particularly its rotary wheel guide 216) is coupled to the bottom surface 504 of the electronic device 502.

While the preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. For example, while an exemplary application for the battery pack is for use with digital cameras, it will be clear that the uses are not so limited. For example, the battery pack could equally be used with a video camera, audio recorder, MP3 player and the like.

What is claimed is:

1. An adjustable, auxiliary battery pack for a digital camera, the digital camera including a camera tripod mount having a threaded cylindrical bore and a power connector for receiving electrical power, the battery pack comprising:
a housing configured to support at least one rechargeable battery cell disposed within the housing, the housing having a predetermined width and a header for providing an electrical power connection between the at least one rechargeable battery cell and a device external to the housing;
a rotary wheel having a diameter greater than the predetermined width of the housing;
a rotary wheel guide for coupling the rotary wheel to the camera tripod mount of the housing, thereby positioning an upper surface of the rotary wheel guide adjacent to a bottom surface of the digital camera; and
an electrical conductor having a first end capable of coupling to the header of the housing and a second end capable of coupling to the power connector of the digital camera, wherein the electrical conductor is coupled to the header and the power connector remote from the upper surface of the rotary wheel guide and the bottom surface of the digital camera.

2. The pack of claim 1, wherein the rotary wheel comprises:
a protrusion disposed on a first surface of the aperture;
a threaded screw coupled to the protrusion; and
finger grips disposed about the circumference of the rotary wheel.

3. The pack of claim 2, wherein the rotary wheel guide comprises an aperture through which the protrusion is inserted, the aperture having sides about its circumference which act as mechanical stops for the protrusion.

4. The pack of claim 3, wherein the diameter of the rotary wheel is greater than twice the distance from the aperture side to an opposite edge of the rotary wheel guide.

5. The pack of claim 4, wherein the housing comprises an upper housing having at least one flat surface and a lower housing.

6. The pack of claim 5, wherein the lower housing comprises:
means for accommodating the at least one rechargeable cell; and
a circuit board having electrical circuits disposed thereon.

7. The pack of claim 5, wherein the lower housing comprises a second, threaded cylindrical bore.

8. The pack of claim 6, wherein the pack further comprises a fuel gauge display.

9. The pack of claim 8, wherein the pack further comprises a connector for coupling to a power supply.

10. The pack of claim 1, wherein the camera tripod mount is substantially concealed, but the header of the housing remains exposed, when the rotary wheel is coupled to the camera tripod mount.
